(19) United States
(12) Patent Application Publication
(10) Pub. No.: US 2015/0153267 A1
(43) Pub. Date: Jun. 4, 2015

(54) Method for Analyzing Interaction force between Molecules

(71) Applicants: Shunxin Zhang, Hebei Province (CN); Yuanyuan Zhang, Hebei Province (CN)

(72) Inventors: Shunxin Zhang, Hebei Province (CN); Yuanyuan Zhang, Hebei Province (CN)

(21) Appl. No.: 14/397,591

(22) PCT Filed: Jul. 9, 2013
(86) PCT No.: PCT/CN2013/079088

§ 371 Date: Oct. 28, 2014

(30) Foreign Application Priority Data
Jun. 9, 2013 (CN) 201310229896.6

(51) Int. Cl. G01N 19/04

(52) U.S. Cl. CPC G01N 19/04

(57) ABSTRACT

A method for analyzing interaction force between molecules, comprising: it's based on Equilibrium Condition Objects, through the one ideal experiment now regarded as no air pressure between the contact surfaces and making experimental analysis on the change of stress on the object of study in a vacuumizing process, obtaining the macro demonstrated size of the molecular force as well display effect of elasticity and friction, verifying the qualitative relationship between the micro demonstrated molecular force and distance, and finally deducing the relationship between existing molecular force and distance.

### TECHNICAL FIELD

The invention combines the molecular force and the object force, which used to be two separated fields, and it is unified into newton's classical mechanics system, belongs to the field of object mechanic study, and in particular relates to a method for studying the interaction force between molecules.

### BACKGROUND

In 1743, Desanguliers, a physicist from the United Kingdom, accidently found a very famous experiment using two lead balls and proposed the adhesive theory of friction afterwards. In 1919, Hardy, a biologist from the same country, did a worldwide well-known experiment using two optic glass slides, which supports the molecular theory and the adhesive theory of friction. As the industry and technology move forward, a new theory, namely “New Adhesive Theory of Friction” that is developed based on the adhesive theory of friction, has been increasingly accepted by the academic world since the last century. For example, the adhesive theory has been adopted in current physics textbooks for ordinary high schools in China that are published by People's Education Press which is a national professional publisher of textbooks. The textbooks mentioned “two pure lead blocks, if pressed tightly together, will stay together under the attraction between molecules and even cannot be pulled apart by hanging a weight on the lead balls; and two optical glass slides with polished, smooth, clean and matching surfaces, if pressed by a force, will adhere together under the attraction between molecules.”

The “new adhesive theory of friction” can be summarized into two viewpoints: 1. A bigger normal pressure can reduce the distance between the contact surfaces of two objects to a point where the attraction between the molecules (atoms) happens, which cannot be achieved in industry or by technology, and thus, the contact surfaces of the objects adhered together at atom level, demonstrating attraction between molecules; and 2. The friction is demonstrated in form of molecular attraction.

Due to questioning and delayed development of the adhesive theory of friction, the invention provides the novel method for analyzing the interaction between molecules, which help drive the study in this field forward.

### SUMMARY OF THE INVENTION

The invention aims to provide the method for analyzing the interaction between molecules, which helps get deep study on the interaction between molecules.

To fulfill the purpose, the application provides a technical scheme below:

The method for analyzing the interaction between molecules comprises the following steps:

Step 1 Preparation

Making two blocks A by gluing 2.30*10⁻¹ kg solid metal iron cylinders whose cross section diameter is 5.0*10⁻² m onto a 2.0*10⁻² kg float flat round glass slide whose diameter is 5.0*10⁻² m and thickness is 5*10⁻³ m; preparing two float flat rectangular glass slides B whose length, width and thickness are 1.05*10⁻¹ m, 7.0*10⁻² m and 5*10⁻³ m, respectively, and drilling a 4*10⁻³ m hole on the end of each rectangular slide; and preparing a bracket, a vacuum hood, a vacuum pump and water;

Step 2 Dripping a drop of water on the surface of the block B, attaching the round glass slide on the block A onto the water film, pressing the glass slide to move the glass slide back and forth, and pressing the two blocks when the obvious increasing friction between the two blocks is felt;

Step 3 Before removing the hand, allowing molecules between the two attached layers to contact completely as the actual contact area of the molecules approaches the nominal contract area of the molecules due to the wetting of the glass by the molecules and the flowability of the molecules as well as the molecular gravity exceeding the maximum attraction demonstrated between the molecules;

Step 4 Removing the hand, and allowing the block A and the block B to attach together under the action of forces such as the atmosphere pressure, wherein the fully contacted areas of the molecules do not change with the increase in the distance between the two attached layers, and the contact surfaces of the block A and the block B are regarded as ideal contact surfaces;

Step 5 Based on the balance conditions for the object, making experimental analysis on the change of stress on the block A in a vacuumizing process, obtaining the macro size of molecular force and elasticity and friction display effect of molecular force, verifying the qualitative relationship between the micro demonstrated molecular force and the distance between molecules, and finally deducing the relationship between existing molecular force and the distance between molecules;

Step 6 Based on the conditions for keeping the balance of objects, analyzing the new adhesive theory of friction, and by the new experimental phenomena obtained via improvement on the historic experiment using 2 leads and the experiment using two optic glass slides, explaining the adhesive theory of friction goes against Newton's laws of motion.

FIG. 2 represents the force diagrams of the block A in three states in a vacuumizing process from standard atmosphere to an ideal vacuum. The gravity G of the block A stays constant in the whole vacuumizing process. As air is sucked out, PS reduces continuously, and the block A stays in a balance state all the time. As PS is the force supporting the block A, the continuous reduction in the PS will lead to continuous decrease in the intermolecular repulsion between the two attached layers, which represents the interaction between molecules, and the continuous enlarging of the distance between the two attached layers, which represents the distance between molecules. And at the same time, the molecular interaction between the contact surfaces changes from the intermolecular repulsion to the attraction, and in the process of change, a state in which the molecular attraction and the molecular repulsion stay in balance is sure to happen. In the balance state, the interaction between the molecules is neither the attraction nor the repulsion and the PS and G offset each other (PS+G=0), and under this condition, the distance between molecules is defined as r₀. Before the balance state, r is less than r₀, so PS+G is less than 0. As suction continues, r will be more than r₀, so PS+G will be more than 0 and the interaction between the molecules changes from the original repulsion to the attraction so as to keep the balance. If ideal vacuum can be achieved, PS is equal to 0, and the F sets off the G (F+G=0, F=−G=−2.5 N) and is applied in the opposite direction with G. Thus, the relationship between intermolecular interaction and intermolecular distance is demonstrated as: when the repulsion is demonstrated, r is less than r₀; when the repulsion and the attraction set off each other and the balance state is achieved, r is equal to r₀; and when the attraction is demonstrated, r is more than r₀.

The experiment has a process in which r grows from r₀ (order of magnitude: 10⁻¹⁰ m) and the attraction F increases from 0 to G (G=2.5 N). However, when the intermolecular distance is more than 10⁻⁹ m, both the attraction and the repulsion nearly approach 0 and can be ignored, so the obvious demonstration of intermolecular attraction does not make sense any more. Thus, the intermolecular attraction F has a peak value near the r₀ in the F−r curve.

In a special state demonstrated in FIG. 3-b, the demonstrated force between water molecules on the whole round contact surfaces is 0 or the average demonstrated force is 0, the average distance is in the center of the circle or at the horizontal diameter, and the distance r between water molecules at the horizontal diameter is equal to r₀. The upper part of the horizontal diameter demonstrates the attraction between water molecules and the lower part demonstrates the repulsion between water molecules, and the repulsion is equal to the attraction. This indicates the mapping, symmetric (about the horizontal diameter) and equivalent relationship between the demonstrated attraction of each pair of water molecules on the upper side of the horizontal diameter and the demonstrated repulsion of each pair of water molecules on the lower side of the horizontal diameter, as well as the symmetric (near r₀) and equivalent relationship between the rate of change of the demonstrated attraction between the water molecules relative to the distance and the rate of the change of the demonstrated repulsion between the water molecules relative to the distance on the intermolecular force-intermolecular distance curve, namely the rates are equal.

In the process that the demonstrated intermolecular attraction grows from the infinitely remote 0 to the maximum value: first, the increase process of the rate of the change of the demonstrated intermolecular attraction relative to the distance reflects the absolute value of the rate of the change of the intermolecular attraction relative to the distance is bigger and grows faster than the absolute value of the rate of the change of the demonstrated intermolecular repulsion relative to the distance; after the rate of the demonstrated force to the distance grows to the maximum value, namely a turning point, the rate of the change of the demonstrated intermolecular attraction relative to the distance starts to reduce, which reflects the absolute value of the rate of the change of the intermolecular repulsion relative to the distance is smaller but grows faster than the absolute value of the rate of the change of the intermolecular attraction to the distance; when the demonstrated intermolecular attraction reaches the maximum value, the rate of the change of the attraction to the distance is 0, which reflects the absolute value of the rate of the change of the intermolecular attraction to the distance is equal to the absolute value of the rate of the change of the intermolecular repulsion to the distance. Therefore, when the distance r is between infinitely small ∞ and 0, the interaction between molecules is demonstrated as the attraction, which does not mean the intermolecular repulsion at any distance within the range reduces or increases faster than the molecular attraction. The conclusion is against the study result on the textbooks, which states “when r is more than r₀, the interaction between the molecules is demonstrated at attraction because the intermolecular repulsion reduces faster than the intermolecular attraction.

### ADVANTAGEOUS EFFECTS

The application combines the demonstrated force between molecules (macro and micro) and ground mechanics, which are two separated study fields, and expands the application of Newton's Mechanics. The invention provides the novel method which uses the balance conditions of the object to solve problems: first, qualitative negative analysis on the principle for building up the new adhesive theory of friction is conducted, and experimental phenomena of the newly designed experiment using two lead cylinders and the experiment using two glass slides overthrow the conclusion that the adhesion is molecular attraction, which is reached based on the original experiment using two lead balls and the original experiment using two optic glass slides, and the old adhesive theory of friction supported by the two experiments, and a new definition at the micro level for friction is given in an ideal physical model; and contact surfaces without air pressure in between are achieved despite the current industry and technology both fall short, and an ideal experiment is realized and comes with a result that proves the elasticity and friction are the centralized demonstration of micro molecular force and that the combination of the friction and the gravity of the molecules is equivalent to the gravity of the molecules, and the friction and the gravity both belong to the classic Newton's Mechanics; and during the ideal experiment, the macro size of the molecular force is measured, the elasticity and friction demonstrations are approved, the relationship between the micro demonstrated molecular force and distance between the molecules is verified, the basis for drawing the intermolecular force-intermolecular distance curve is emphasized, a new relationship of the intermolecular force and the intermolecular distance is determined, and the new understanding of the interaction between molecules is achieved.

### BRIEF DESCRIPTION OF THE DRAWINGS

FIG. 1 New intermolecular force—intermolecular distance curve;

FIG. 2 Force diagram of A under condition that B is placed on the bracket horizontally;

FIG. 3 Force diagram of A under condition that B is hung on the bracket vertically;

FIG. 4 Schematic diagram showing friction is unnecessarily demonstrated in form of molecular attraction.

### DETAILED DESCRIPTION OF THE EMBODIMENTS

A method for analyzing the interaction between molecules, which comprises the following steps:

Step 1 Preparation

Making two blocks A by gluing 2.30*10⁻¹ kg solid metal iron cylinders whose cross section diameter is 5.0*10⁻² m onto a 2.0*10⁻² kg float flat round glass slide (optical glass slide preferred) whose diameter is 5.0*10⁻² m and thickness is 5*10⁻³ m; preparing two float flat rectangular glass slides B whose length, width and thickness are 1.05*10⁻¹ m, 7.0*10⁻² m and 5*10⁻³ m, respectively, and drilling a 4*10⁻³ m hole on the end of each rectangular slide; and preparing a bracket, a vacuum hood , a vacuum pump and water;

Step 2 Dripping a drop of water on the surface of the block B, attaching the round glass slide on the block A onto the water film, pressing the glass slide to move the glass slide back and forth, and pressing the two blocks when the obvious increasing friction between the two blocks is felt;

Step 3 Before removing the hand, allowing water molecules between the two attached layers to contact completely as the actual contact area of the water molecules approaches the nominal contract area of the water molecules due to the wetting of the glass by the water molecules and the flowability of the water molecules as well as the water molecular gravity exceeding the maximum attraction demonstrated between the water molecules;

Step 4 Removing the hand, wherein the contact areas do not change as the increase in the distance between the two attached layers, the water molecules studied, as if receiving a force completely applied by the water molecules on the other side, apply in a vertical direction a tangential molecular force (friction in the micro definition) that is far greater than the water molecular gravity and at the same time, bear a downward friction applied by the water molecules in the object, thereby keeping balance and loosing flowability like solid molecules; and allowing the block A and the block B to stay together, wherein the contact area under this condition is regarded as the ideal contact area;

Step 5 Based on the balance conditions for the object, making experimental analysis on the change of stress on the block A in the vacuumizing process, obtaining the macro size of molecular force and elasticity and friction display effect of molecular force, verifying the qualitative relationship between the micro demonstrated molecular force and the distance between molecules, and finally deducing the relationship between existing molecular force and the distance between molecules,.

Step 6 Based on the conditions for keeping the balance of objects, analyzing the new adhesive theory of friction, and by the new experimental phenomena obtained via improvement on the historic experiment using 2 leads and the experiment using two optic glass slides, explaining the adhesive theory of friction goes against Newton's laws of motion.

### I Elasticity Demonstration and Experimental Analysis:

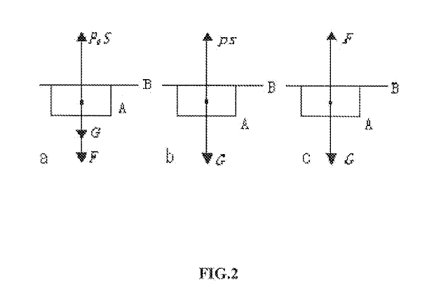

1. During experiment conducted in the air, forces born by A are represented in FIG. 2-a.

(1) The gravity G=2.30*10⁻¹ kgf+2.0*10⁻² kgf=2.50*10⁻¹ kgf=2.5 N (based on one block A, vertically downward direction as positive direction, and g being 10 m/s²); (2) the air molecular pressure (P₀S=P₀R²π=−10⁴*(2.5*10⁻²)²*3.14 kgf=−196.25 N) is demonstrated as elasticity; and (3), the normal repulsion between water molecules (F=−P₀S−G=196.25 N−2.5 N=193.75 N) is demonstrated as elasticity;

Summary: If the gravity of the block is less than P₀S, the force between the water molecules is demonstrated as repulsion and the block bears three forces;

When the gravity of the block is equal to P₀S, the force between the water molecules is 0, and the block bears two forces;

And when the gravity of the block is more than P₀S, the force between the water molecules is attraction, and the block bears three forces.

### 2. Experiment in Vacuum

(1). A special state in the vacuumizing process is as follows: After the switch of the vacuum pump is started, when pressure applied upward by the air molecules to the lower bottom surface of the metal iron cylinder offsets the gravity, the molecular attraction between the contact surfaces is equal to the molecular repulsion, and the micro molecular force is demonstrated (macro demonstration) as 0. The forces born by A are represented in the FIG. 2-b: \textcircled{1}, the gravity G is 2.5 N; and \textcircled{2} the air molecule pressure PS is equal to −G and is 2.5 N, and is demonstrated as elasticity.
(2). When suction is continued till an ideal vacuum state, the forces born by A are represented in the FIG. 2-c: \textcircled{1}, the gravity G is 2.5 N; and \textcircled{2} the normal water molecular attraction F is equal to −G and is 2.5 N, and F is demonstrated as elasticity.
3. Relationship I between the demonstrated intermolecular force and the intermolecular distance is as follows:
FIG. 2 is the force diagram of the block A in three different states during the suction from the standard atmosphere to the ideal vacuum. In the whole suction process, the gravity G of the block A stays constant. As suction continues, PS reduces continuously, and the block A stays in the balance state all the time. Because the PS is the force supporting the block A upward, the continuous reduction of the PS will allow the intermolecular repulsion between the two attached layers, which represents the demonstrated force between the molecules, to reduce continuously, and the distance between the two attached layers, which represents the distance between the molecules, to enlarge continuously, and at the same time, the molecular force between the contact surfaces is changed from the original demonstrated intermolecular repulsion to the intermolecular attraction, during which process, the state in which the existing intermolecular attraction and the existing intermolecular repulsion reach balance is sure to happen. In the balance state, the intermolecular force is neither demonstrated as the attraction nor the repulsion and the combined force of PS and G is 0. If the intermolecular distance in this state is defined as the r₀, the intermolecular distance r before the state is less than r₀, and the combined force of the PS and G is less than 0; if suction continues till r is more than r₀, the combined force of PS and G is more than 0, and the intermolecular force is changed from the original repulsion to the attraction in order to keep the balance state. If the ideal vacuum state can be achieved and PS is 0, the F which is demonstrated as attraction is of the same size but in the opposite direction as G (F+G=0, F=−G=2.5 N). From the above, the relationship between the intermolecular force and the intermolecular distance is as follows: when the intermolecular force is demonstrated as repulsion, r is less than r₀; when the attraction is equal to the repulsion, r is equal to r₀; when the intermolecular force is demonstrated as the attraction, r is more than r₀.
The experiment has a process in which r grows from r₀ (order of magnitude: 10⁻¹⁰ m) and the attraction F increases from 0 to G (G=2.5 N). However, when the intermolecular distance is more than 10⁻⁹ m, both the attraction and the repulsion nearly approach 0 and can be ignored, so the obvious demonstration of intermolecular attraction does not make sense any more. Thus, the intermolecular attraction F has a peak value near the r₀ in the F−r curve.

### II Friction Demonstration and Experimental Analysis:

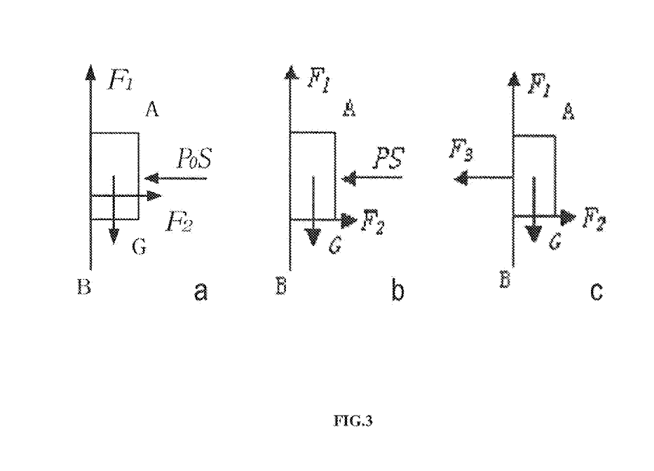

1. In the experiment conducted in the air, the forces born by A are represented by FIG. 3-a: (1) the gravity G is 2.5 N; (2) the air molecular pressure P₀S is −196.25 N (based on the horizontally rightward direction as positive direction) and is demonstrated as elasticity; (3) normal water molecular repulsion F₂ (F₂=−P₀S=196.25 N) is demonstrated as elasticity; and (4) tangential water molecular repulsion F₁ (F₁=−G=−2.5 N) is demonstrated as friction.

2. Experiment Conducted in Vacuum

(1) A special state happens in the vacuumizing state: during suction, the normal water molecule repulsion F between the round contact surfaces is always in balance with the outside air pressure PS, the action line of the repulsion F moves downward as the suction continues till the lowest point of the block A, and at this time, F₂ can be calculated based on the side height (1.5*10⁻² m , calculation method of the height is ignored) of the metal iron cylinder, the horizontal diameter of the round contact surfaces as the axis and ΣM=0 (2.5*10⁻² m*F₂=2.5*10⁻³ m*2.0*2.0*10⁻² kgf+(5*10⁻³+7.5*10⁻³)m*2.30*10⁻¹ kgf (F₂=0.117 kgf=1.17 N). The force born by A is represented by the FIG. 3-b: \textcircled{1} the gravity G is 2.5 N; \textcircled{2} the normal molecular repulsion F₂ is 1.17 N and is demonstrated as elasticity; \textcircled{3} the air molecular pressure PS is −1.17 N, and is demonstrated as elasticity; and \textcircled{4} the tangential water molecule force F₁ (including water molecule attraction and water molecule repulsion between the two contact surfaces) is −2.5 N, and is demonstrated as friction.

(2) As the suction continues till an ideal vacuum state, the average force of water molecules between the two contact surfaces is centrally demonstrated as follows: the water molecule attraction in the center of the average distance equivalently replaces the air pressure PS in a special state. Forces born by A are illustrated in the FIG. 3-c: \textcircled{1} gravity G (G=2.5 N); \textcircled{2} normal water molecule attraction F₃ (F₃=−1.17 N) demonstrated as elasticity; normal water molecule repulsion F₂ (F₂=1.17 N) demonstrated as elasticity; and \textcircled{4} tangential water molecule attraction F₁ (F₁=−2.5 N) demonstrated as friction.

3. Relationship II Between the Demonstrated Intermolecular Force and the Intermolecular Distance is as Follows:

In the special state represented by the FIG. 3-b, the demonstrated force between the water molecules on the round contact surfaces is 0 or the demonstrated average force is 0, and the average distance is in the center of the circle or at the horizontal diameter, and the distance r between the water molecules at the horizontal diameter is equal to r₀. The upper part of the horizontal diameter demonstrates the attraction between water molecules and the lower part demonstrates the repulsion between water molecules, and the repulsion is equal to the attraction in size. This indicates the mapping, symmetric (about the horizontal diameter) and equivalent relationship between the demonstrated attraction between each pair of water molecules on the upper side of the horizontal diameter and the demonstrated repulsion between each pair of water molecules on the lower side of the horizontal diameter, as well as the symmetric (about r₀) and equivalent relationship between the rate of change of the demonstrated attraction between the water molecules relative to the distance and the rate of the change of the demonstrated repulsion between the water molecules relative to the distance on the intermolecular force-intermolecular distance curve, namely the rates are constant near the r₀.

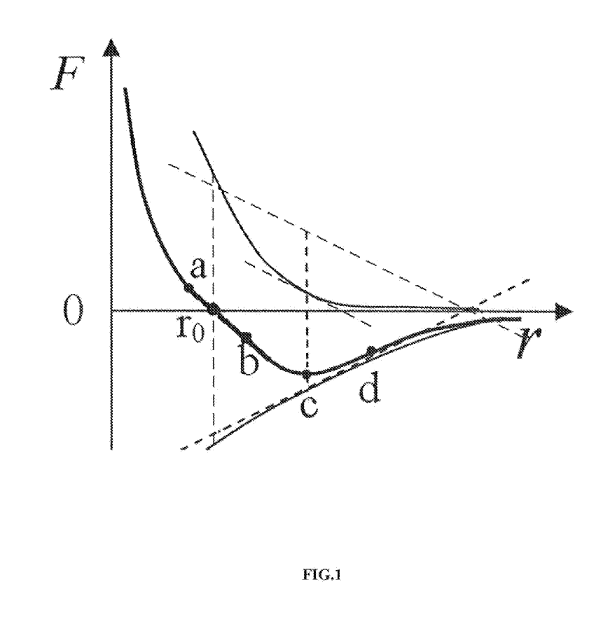

### III Basis for Drawing Intermolecular Force—Intermolecular Distance Curve Represented by FIG. 1

### 1. Demonstrated Force and Characteristics of the Rate of the Change of the Demonstrated Force Relative to the Distance

\textcircled{1} When the intermolecular force is demonstrated as the repulsion, r is less than r₀; when the repulsion keeps balance with the attraction, r is equal to r₀; and when the intermolecular force is demonstrated as the attraction, r is more than r₀.
\textcircled{2} When the intermolecular attraction, the F−r curve has a peak near r₀.
\textcircled{3} The rate of the change of the intermolecular force demonstrated near r₀ to the intermolecular distance is a constant.

### 2. Exists Force and Characteristics of the Rate of the Change of the Demonstrated Force Relative to the Distance

In the change process of the demonstrated intermolecular attraction from an infinitely remote value to the maximum value: first, during the increase of the rate of the change of the demonstrated attraction relative to the distance, the absolute value of the rate of the change of the demonstrated intermolecular attraction relative to the distance is greater and grows faster than the absolute value of the rate of the change of the demonstrated intermolecular repulsion to the distance; after the rate of the change of the demonstrated force relative to the distance increases to a maximum value, which is a turning point, the rate of the change of the demonstrated attraction relative to the distance starts to reduce, which reflects the absolute value of the rate of the change of the demonstrated intermolecular repulsion is smaller but grows faster than the absolute value of the rate of the change of the intermolecular attraction relative to the distance; when the demonstrated intermolecular attraction reaches a maximum value, the rate of the change of the demonstrated intermolecular attraction to the distance is 0, which reflects the rate of the change of the demonstrated intermolecular attraction relative to the distance is equal to the absolute value of the rate of the change of the demonstrated intermolecular repulsion to the distance. Thus, when the r is less than ∞ and more than r₀, the intermolecular force is demonstrated as the attraction, but this does not mean the intermolecular repulsion in any sector of the range grows slower or faster than the demonstrated intermolecular attraction, which denies the “study result” on the textbook that “when r is more than r₀, the intermolecular force is demonstrated as the attraction because the intermolecular repulsion reduces faster than the intermolecular attraction, and an subject diagram.

### Analysis on the Adhesive Theory of Friction

### I Theoretical Analysis

The “new adhesive theory of friction” can be summarized into two viewpoints: 1. A bigger normal pressure can reduce the distance between the contact surfaces of two objects to a point where the attraction between the molecules (atoms) happens, which cannot be achieved in industry or by technology, and thus, the contact surfaces of the objects adhere together at atom level, demonstrating attraction between molecules; and 2. The friction is demonstrated in form of molecular attraction.

As for the “first” viewpoint, when a normal pressure is applied, the force which offsets the normal pressure is the repulsion between the relatively small number of molecules on the top, and even the normal pressure is withdrew, the surfaces of the objects can still be combined together under the action of the atmosphere. Of course, the distance between molecules in the part where the slightly raised outside contact surfaces has a 10⁻⁸ m or even bigger gap is sure to reduce to a range in which the attraction between the molecules (atoms) happens, and thus, the demonstrated force is the attraction, but it is the intermolecular attraction demonstrated by the parts that leads to the fact that the intermolecular force between the two contact surfaces is more likely to be demonstrated as the intermolecular repulsion. As a result, the principle on which the new adhesive theory of friction is built ignores the action of the relatively small number of molecules which have smaller distance and pressured flat on the top and demonstrate repulsion as well as the action of atmospheric pressure. This is just like what is said in the textbook: when two lead blocks or two optic glass slides are combined together (even some air molecules are left between the tightly contacted parts in the experiment using two lead balls and the experiment using two optical glass slides, the force between the air forces is more obvious than the force between molecules between the contact surfaces of the two lead balls or two optic glass slides, which leads to the loss of the movement features of these air molecules as gas molecules. That is, the pressure of the air in the tightly contacted part of the two lead balls or two optic glass slides is 0), the lower block can be treated as the object of study, and since the lower block is in a static state, the combined force of the external forces applied on the block must be 0. However, the quantitative relationship between the actual contact area and the nominal contact area (the actual contact area=intermolecular repulsion contact areas+intermolecular attraction contact area; and the nominal contact area=actual contact area+macro contact and front area bearing no intermolecular force) and the quality of the study object are not analyzed in the two experiment, and the attraction is insisted under the condition of a standard atmosphere. Therefore, subjective judgment is made without evidence under the condition that nonideal contact surfaces are used under “restriction” of industry and technology. It is also acceptable to rethink by comparison that whether the force between the two half balls in the Magdeburg hemispheres test is the attraction and the gravity of the object hung is equal to the pull forces of eight horses in one direction?

Even all external forces applied on the stressed object are not taken into consideration, by determining the demonstrated force between molecules is the attraction based on a bigger weight hung on the object or based on the combination, the new adhesive theory of friction is against the balance conditions for the object as well the Newton's laws of motion.

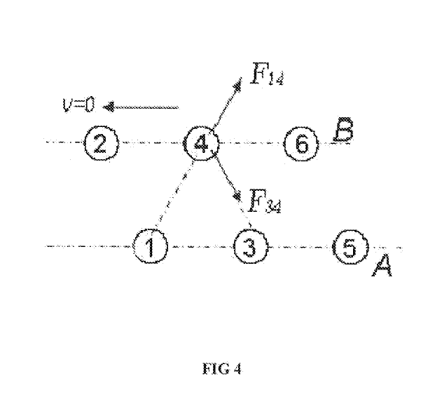

As for the “second” viewpoint, a common environment can be assumed: for example fully contacted ideal contact surfaces (in the “gap” formed by which, no air pressure exists.) As shown in the FIG. 4), in the air, usually the intermolecular repulsion is demonstrated between the two surfaces, and r is less than r₀. Suppose . . . \textcircled{1} . . . \textcircled{3} . . . \textcircled{5} represent molecules on the surface A, and . . . \textcircled{2} . . . \textcircled{4} . . . \textcircled{6} represent molecules on the surface B. When the surface B shows a trend to move leftward relative to the surface A, the forces applied by the molecules in the surface B, onto the . . . \textcircled{2} . . . \textcircled{4} . . . \textcircled{6} remain constant in size and spatial direction if the balance positions of the . . . \textcircled{2} . . . \textcircled{4} . . . \textcircled{6} relative to the molecules in the surface B do not change. But the distances of the . . . \textcircled{2} . . . \textcircled{4} . . . \textcircled{6} relative to the . . . \textcircled{1} . . . \textcircled{3} . . . \textcircled{5} on the surface A change, so the sizes and spatial directions of the forces applied by the . . . \textcircled{1} . . . \textcircled{3} . . . \textcircled{5} on the . . . \textcircled{2} . . . \textcircled{4} . . . \textcircled{6} change. If the molecule \textcircled{4}, as the stressed object, shows the relative movement trend above, the distance between the \textcircled{4} and the \textcircled{3} increases, the repulsion of the \textcircled{3} to the \textcircled{4} reduces, and the direction of the combined repulsion F34 applied on the \textcircled{4} by the \textcircled{3} along the line connecting the \textcircled{4} and \textcircled{3} is \textcircled{4}→\textcircled{3}; the distance between the \textcircled{4} and the \textcircled{1} reduces, and the repulsion of the \textcircled{1} to the \textcircled{4} increases, and the combined repulsion F14 applied onto the \textcircled{4} along the line connecting the \textcircled{4} and the \textcircled{1} is \textcircled{1}→\textcircled{4}. This indicates the \textcircled{4} has a trend of moving leftward relative to the surface A, and bears a molecular repulsion which hinders its trend of relative movement and seems all applied by the molecules on the other surface, that is, the friction. In the same way, analysis is conducted under the condition that r is equal to r₀ and the condition that r is more than r₀ and small than rm (rm is supposed to be the intermolecular distance in the state when the attraction reaches the maximum value. In the process that the distance between the two contact surfaces, which represents the distance between molecules, moves from the infinitely remote value to the rm, the rate of the change of the demonstrated force between the molecules relative to the distance changes from 0 to the maximum value to 0; in the process, the demonstrated force between molecules increases to the maximum value; as the two contact surfaces become smoother, the number of molecules tightly contact increases till the most, and the demonstrated attraction between the two surfaces increases to the maximum value; and when the two surfaces have relative movement or relative movement trend, the gearing elasticity, which is along the contact surfaces, of the friction defined in a macro sense reduces till 0; the friction transits from the distance in macro definition to the distance in micro definition, and the contact surfaces reach the requirements for an ideal physical model. By using the balance conditions for the object that are used to solve ground mechanical issues, which also represent a method to solve micro demonstrated intermolecular force, the friction in the three states in which the two surfaces in the ideal model have closer distance is defined at micro level). The analysis of two states show the friction in the micro sense does not be necessarily demonstrated in form of molecular force, but in the form of the component force, which is along the opposite direction of the movement trend, of the demonstrated molecular attraction and (or) repulsion.

### II Historical Improvement in the Two Famous Experiments

1. Improvements in the experiment using two optical glass slides:
Based on modern industry and technology, an optical flat glass slide and a round concave glass slide are combined together, and an interferogram of an air film which has a part extended to the margin is formed. This shows the air in the contacted part with interferogram is communicated with the outside, and the two contacted surfaces have no intermolecular force in between. According to the balance conditions of the object, in the environment, only the intermolecular repulsion rather than the molecular attraction is demonstrated between the contacted surfaces because the gravity of the round flat glass slide is far smaller than the external atmosphere corresponding to the actual contact area. Thus, the adhesive theory of friction is denied.
2. Improvements in the experiment using two lead balls:
A weight of proper mass is hung to the bottom of the combined two lead cylinders before the vacuum experiment in the device. In the vacuum experiment, the two lead cylinders do not separate, which indicates the demonstrated force is the attraction in the vacuum state, and the attraction is smaller than the maximum force needed to separate the two lead cylinders; with the mass of the hung weight gradually increased, vacuum experiments are repeated for lots of times till the two lead cylinders separate (the separate rate is 100%). The separation of the two lead cylinders in the vacuum state indicates that the atmospheric pressure plays a significant role in the combination of the two lead balls, instead of the intermolecular attraction, which denies the adhesive theory of friction.
At last, it should be noted that: the foregoing description of the embodiments of the invention has been provided for the purpose of illustration and description. It is not intended to limit the embodiments. Obviously, many modifications and variations will be apparent to practitioners skilled in the art. It is not intended to be exhaustive the embodiments to the precise forms disclosed. Thus, it is intended that the invention covers such obvious modifications and variations provided they come within the scope of the appended claims and their equivalents.

1. A method for analyzing interaction between molecules, which is characterized by comprising the following steps:
Step 1 Preparation
Making two blocks A by gluing 2.30*10⁻¹ kg solid metal iron cylinders whose cross section diameter is 5.0*10⁻² m onto a 2.0*10⁻² kg float flat round glass slide whose diameter is 5.0*10⁻² m and thickness is 5*10⁻³ m; preparing two float flat rectangular glass slides B whose length, width and thickness are 1.05*10⁻¹ m, 7.0*10⁻² m and 5*10⁻³ m, respectively, and drilling a 4*10⁻³ m hole on the end of each rectangular slide; and preparing a bracket, a vacuum hood, a vacuum pump and water;
Step 2 Dripping a drop of water on the surface of the block B, attaching the round glass slide on the block A onto the water film, pressing the glass slide to move the glass slide back and forth, and pressing the two blocks when the obvious increasing friction between the two blocks is felt;
Step 3 Before removing the hand, allowing molecules between the two attached layers to contact completely as the actual contact area of the molecules approaches the nominal contract area of the molecules due to the wetting of the glass by the molecules and the flowability of the molecules as well as the molecular gravity exceeding the maximum attraction demonstrated between the molecules;
Step 4 Removing the hand, and allowing the block A and the block B to attach together under the action of forces such as the atmosphere pressure, wherein the fully contacted areas of the molecules do not change with the increase in the distance between the two attached layers, and the contact surfaces of the block A and the block B are regarded as ideal contact surfaces;
Step 5 Based on the balance conditions for the object, making experimental analysis on the change of stress on the block A in a vacuumizing process, obtaining the macro size of molecular force and elasticity and friction display effect of molecular force, verifying the qualitative relationship between the micro demonstrated molecular force and the distance between molecules, and finally deducing the relationship between existing molecular force and the distance between molecules.
